(19) United States
(12) Patent Application Publication
(10) Pub. No.: US 2015/0033844 A1
(43) Pub. Date: Feb. 5, 2015

(54) FREQUENCY MODULATION CONTINUOUS WAVE RADAR LEVEL METER AND MEASURING METHOD FOR THE SAME

(71) Applicant: FINETEK CO., LTD., New Taipei (TW)

(72) Inventors: Jia-Hung CHEN, New Taipei (TW); Shu-Chien CHENG, New Taipei (TW); Chao-Kai CHENG, New Taipei (TW); Yi-Wei LIU, New Taipei (TW)

(73) Assignee: FINETEK CO., LTD., New Taipei (TW)

(21) Appl. No.: 13/954,267

(22) Filed: Jul. 30, 2013

(51) Int. Cl. G01F 23/284

(52) U.S. Cl. CPC G01F 23/284
USPC 73/290 V

(57) ABSTRACT

A measuring method for a frequency modulation continuous wave radar level meter is performed after presetting a previous-cycle weight and a current-cycle weight and acquiring a measured result in a previous cycle, and has steps of constantly transmitting a frequency modulation (FM) signal and receiving multiple reflected signals, obtaining a frequency difference between the FM signal and each reflected signal, selecting a characteristic frequency from a frequency spectrum, and calculating a measured result in the current cycle taken as the measured result in the previous cycle for calculating a measured result in a next cycle with a sum of a product of the measured result in the previous cycle and the previous-cycle weight and a product of a distance corresponding to the characteristic frequency so as to reduce variations of the measured result in each cycle and facilitate statistical analysis.

### BACKGROUND OF THE INVENTION

1. Field of the Invention

The present invention relates to a frequency modulation continuous wave (FMCW) radar level meter, and more particularly to an FMCW radar level meter being adaptable to river level measurement with high variations and suppressing the degree of variations of measured results thereof.

2. Description of the Related Art

Radar level meters are usually used to measure distance to a solid object or a liquid level. According to types of measuring methods, radar level meters can be generally classified as time domain reflection (TDR) radar level meters and frequency modulation continuous wave (FMCW) radar level meters. The FMCW radar level meters adopt calculation methods that are more complicated than those of the TDR radar level meters, while the calculation by the FMCW radar level meters is more accurate than that by the TDR radar level meters.

With reference to FIG. 6, a conventional FMCW radar level meter 70 periodically performs the following steps upon measuring liquid level.

Step one: Constantly transmit a frequency modulation (FM) signal Ts, constantly raise (or lower) the frequency of the FM signals Ts, and receive multiple reflected signals Rs generated when the FM signals Ts are reflected by an object surface and/or a liquid surface.

Step two: Perform down-conversion mixing processing of the transmitted FM signal and the received reflected signals to obtain frequency differences between the FM signal and each of the reflected signals, and output beat signals as shown in FIG. 7.

Step three: Perform a Fourier transform on the beat signals in FIG. 7 to generate a discrete frequency spectrum as shown in FIG. 8, and select a characteristic frequency fp from the frequency spectrum with the peak intensity.

Step four: Calculate a measured distance R with the characteristic frequency fp in the following equation

$$R = \frac{fp \times C \times T}{2 F}$$

Where

C: Speed of light;

T: Total time required to transmit the FM signal Ts (or receive the reflected signals Rs);

F: Total bandwidth of the FM signal Ts (or the reflected signals Rs).

Given an example with a time period from t₀ to t₂, the total time T is equal to (t₂−t₀), the total bandwidth F is equal to (the frequency of the FM signal Ts corresponding to t₂ minus the frequency of the FM signal Ts corresponding to t₀).

Conventional FMCW radar level meters are oftentimes used to measure a liquid level of an industrial container. As the liquid level inside an industrial container only has minor and slow fluctuations during liquid feed or discharge, the distance R measured in each cycle also vary insignificantly when the conventional FMCW radar level meters periodically perform the foregoing steps. However, when the conventional FMCW radar level meters are used to measure water levels of rivers, surge waves generated in rivers can make the distances measured by the FMCW radar level meters in different cycles deviating dramatically. The calculated results are so diffusive that they are not appropriate for architects or engineers to assess average water levels of rivers.

Furthermore, as industrial containers have semi-closed space therein, each FM signal Ts may lead to multiple reflected signals Rs. With reference to FIG. 8, a spectrum is obtained after the conventional FMCW radar level meters perform a Fourier transform. Picking a signal with the peak intensity in the step of selecting the characteristic frequency could be accurate enough to measure the liquid level inside an industrial container. To measure river level in an open space, the way of selecting the characteristic frequency fails to have sufficient accuracy in determining river level.

### SUMMARY OF THE INVENTION

An objective of the present invention is to provide an FMCW radar level meter and a measuring method for the same capable of suppressing variations of measured results and facilitating statistical analysis of the average of the measured results.

To achieve the foregoing objective, the measuring method for a frequency modulation continuous wave radar level meter, presetting a previous-cycle weight and a current-cycle weight less than the previous-cycle weight, and after acquiring a measured result in a previous cycle, the measuring method has steps of:

constantly transmitting a frequency modulation (FM) signal, constantly varying a frequency of the FM signal, and receiving multiple reflected signals of the FM signal;

performing down-conversion mixing processing of the FM signal and the reflected signals, obtaining a frequency difference between the FM signal and each reflected signal, and performing a Fourier transform to generate a discrete frequency spectrum according to the frequency differences;

selecting a characteristic frequency from the discrete frequency spectrum; and

calculating a measured result in the current cycle, wherein a sum of a product of the measured result in the previous cycle and the previous-cycle weight and a product of a distance corresponding to the characteristic frequency and the current-cycle weight is used to calculate a measured result in the current cycle, and the measured result in the current cycle is taken as the measured result in the previous cycle for calculating a measured result in a next cycle.

To achieve the foregoing objective, the FMCW radar level meter has a transceiving antenna and a processing unit.

The processing unit is connected to the transceiving antenna, is built in with a measuring procedure, a previous-cycle weight, and a current-cycle weight; after acquiring a measured result in a previous cycle, the processing unit periodically performs the measuring procedure; when performing the measuring procedure, the processing unit constantly transmits a frequency modulation (FM) signal, constantly varies a frequency of the FM signal, receives multiple reflected signals of the FM signal, performs down-conversion mixing processing of the FM signal and the reflected signals, obtains a frequency difference between the FM signal and each reflected signal, generates a frequency spectrum according to the frequency differences, selects a characteristic frequency from the frequency spectrum, calculates a measured result in the current cycle with a sum of a product of the measured result in the previous cycle and the previous-cycle weight and a product of a distance corresponding to the characteristic frequency, and sets the measured result in the current cycle as the measured result in the previous cycle for calculating a measured result in a next cycle.

The FMCW radar level meter and the measuring method for the same take the measured result (the distance corresponding to the characteristic frequency) into account when calculating a measured result in each cycle, and calculate the weighted effect on the measured result in the previous cycle and the distance corresponding to the characteristic frequency with the previous-cycle weight and the current-cycle weight to obtain the measured result in the current cycle. As the previous-cycle weight is larger, when large fluctuation of liquid level occurs, the measured result in each cycle will approach the measured result in the previous cycle, thereby suppressing the variations of the measured result in each cycle and facilitating measurement of flowing liquid levels, such as river level.

Additionally, in the step of selecting the characteristic frequency, a characteristic sampled point corresponds to a highest frequency in the frequency spectrum because there are no multiple reflected signals during measurement of river level as in a closed space and the river surface is usually the lowest place around (the farthest place to the FMCW radar level meter). Accordingly, a highest characteristic frequency and largest frequency difference between the FM signal and the reflected signal is selected, thereby ensuring a largest measured distance and highest accuracy in measurement and facilitating measuring river level in an open space.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an FMCW radar level meter in accordance with the present invention;

FIG. 2 is a flow diagram of a measuring procedure built in a processor of the FMCW radar level meter in FIG. 1;

FIG. 3 is a flow diagram of a step of selecting a characteristic frequency of the measuring procedure in FIG. 2;

FIG. 4 is a frequency-intensity diagram of a discrete frequency spectrum obtained from the step of selecting a characteristic frequency in FIG. 3;

FIG. 5 is a schematic view of measuring a river level with the FMCW radar level meter in accordance with the present invention;

FIG. 6 is a schematic view of a conventional FMCW radar level meter for measuring a liquid level inside a liquid container;

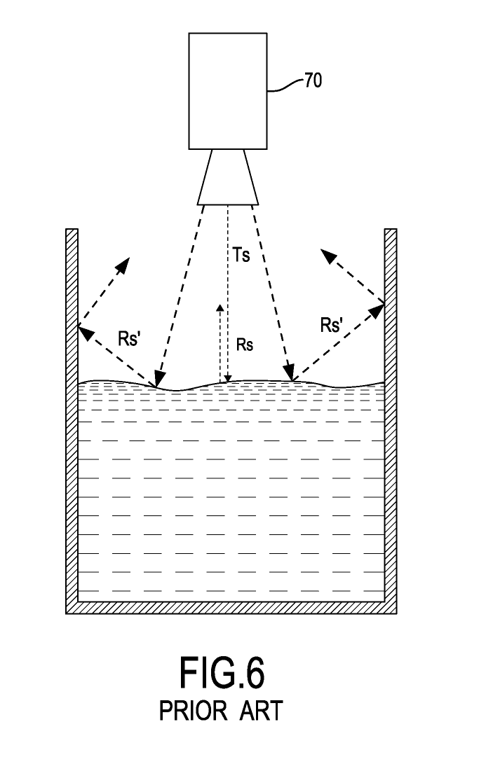

FIG. 7 is a time-frequency graph of FM signals and reflected signals obtained by the conventional FMCW radar level meter in FIG. 6; and

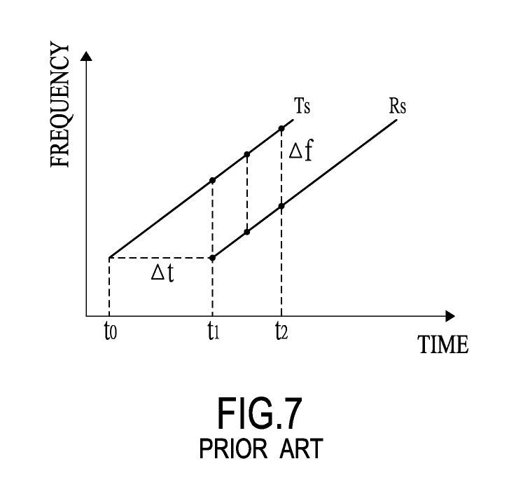

FIG. 8 is a frequency-intensity diagram of a discrete frequency spectrum obtained from the conventional FMCW radar level meter in FIG. 6.

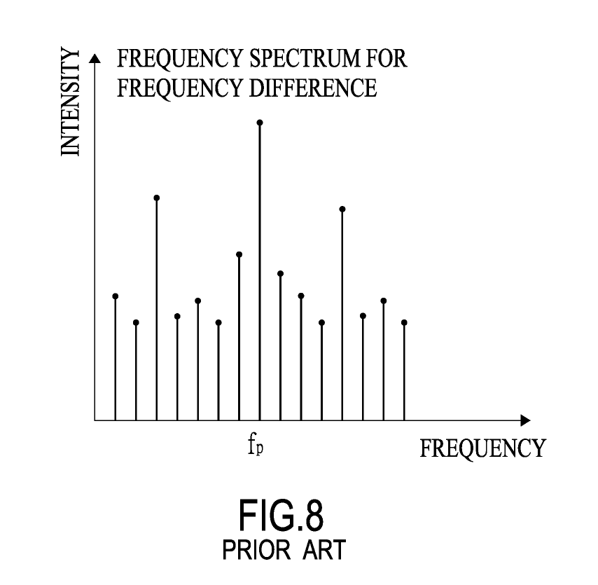

### DETAILED DESCRIPTION OF THE INVENTION

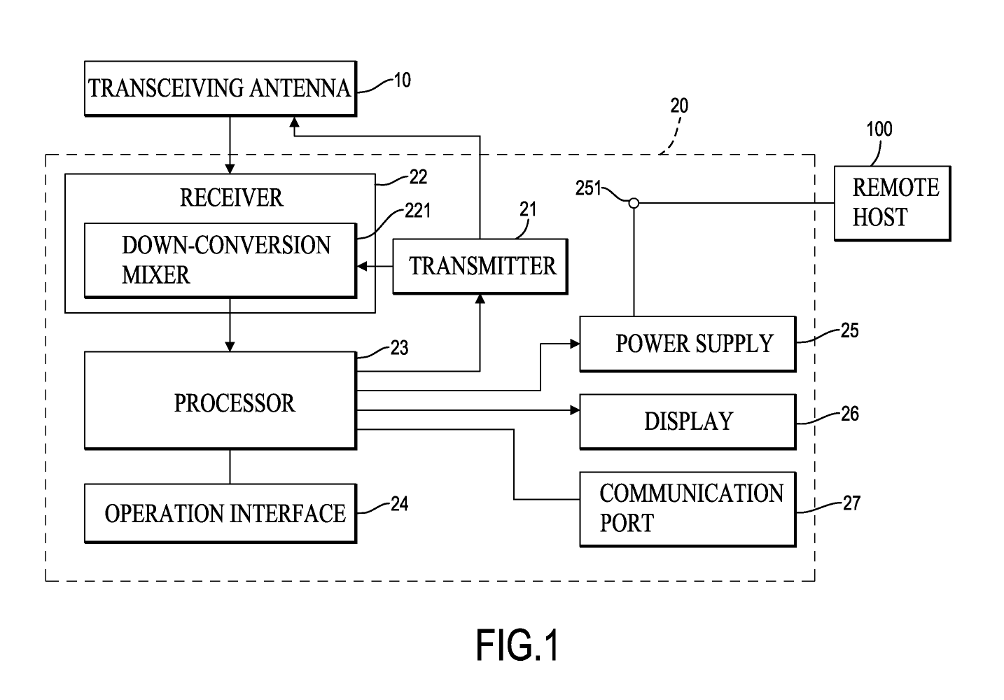

With reference to FIG. 1, an FMCW radar level meter in accordance with the present invention has a transceiving antenna 10 and a processing unit 20.

The transceiving antenna 10 serves to transmit a frequency modulation signal Ts and receive multiple reflected signals Rs.

The processing unit 20 is connected to the transceiving antenna 10, and is built in with a measuring procedure, a previous-cycle weight Pₐ and a current-cycle weight P_{b}. The previous-cycle weight Pₐ is greater than the current-cycle weight P_{b}. For example, the previous-cycle weight Pₐ is 0.9, and the current-cycle weight P_{b} is 0.1. The processing unit 20 has a transmitter 21, a receiver 22, a processor 23, an operation interface 24, a power supply 25, a display 26, and a communication port 27.

The transmitter 21 is connected to the transceiving antenna 10, and outputs the FM signal Ts to the transceiving antenna 10 for the transceiving antenna 10 to transmit the FM signal Ts.

The receiver 22 is connected to the transceiving antenna 10 and the transmitter 21 to receive the reflected signals Rs from the transceiving antenna 10 and receive the FM signal Ts from the transmitter 21, and has a down-conversion mixer 221. The down-conversion mixer 221 performs down-conversion mixing processing of the transmitted FM signal and the received reflected signals to obtain the frequency differences between the FM signals and each of the reflected signals, and output beat signals according to the frequency differences.

The processor 23 is connected to the transmitter 21 and the down-conversion mixer 221 of the receiver 22, and is built in with the measuring procedure, the previous-cycle weight Pₐ, and the current-cycle weight P_{b}. Detailed description of the measuring procedure is discussed later.

The operation interface 24 is connected to the processor 23, and serves to set up the previous-cycle weight Pₐ, and the current-cycle weight P_{b}.

The power supply 25 is connected to the processor 23 for the processor 23 to adjust consumed current of the power supply 25, and has a current detection terminal 251 to be connected to a remote host 100 for the remote host 100 to detect the consumed current of the power supply 25.

The display 26 is connected to the processor 23, and serves to display the previous-cycle weight Pₐ and the current-cycle weight P_{b}.

The communication port 27 is connected to the processor 23 and the remote host 100 for the remote host 100 to set up the previous-cycle weight Pₐ and the current-cycle weight P_{b} in the processor 23.

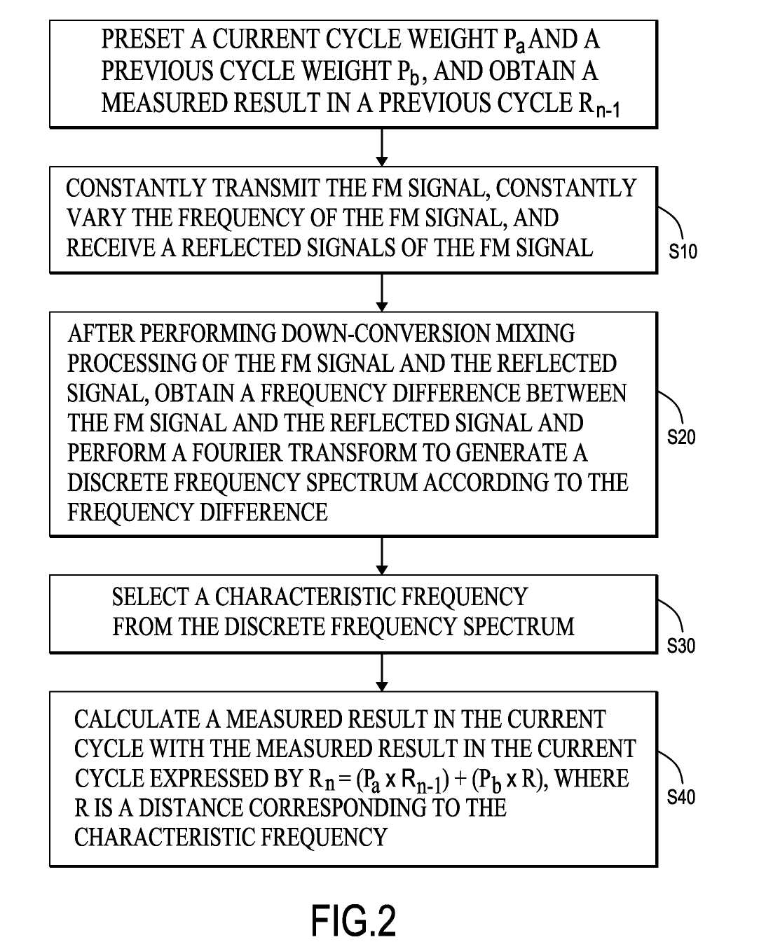

With reference to FIG. 2, after acquiring a measured result Rₙ₋₁ in a previous cycle, the processor 23 in the processing unit 20 periodically performs the measuring procedure. As measuring methods for the measured result in the previous cycle are not exclusive, the measuring procedure includes the following steps.

Step S10: The processor 23 controls the transmitter 21 to constantly output the FM signal Ts to the transceiving antenna 10 for the transceiving antenna 10 to transmit the FM signal Ts, constantly raises (or lowers) the frequency of the FM signal Ts, and receives multiple reflected signals Rs of the FM signal through the transceiving antenna 10.

Step S20: After the down-conversion mixer 221 of the receiver 22 performs down-conversion mixing processing of the FM signal Ts outputted from the transmitter 21 and the reflected signals Rs received by the receiver 22, the processor 23 obtains a frequency difference between the FM signal and each reflected signal and performs a Fourier transform to generate a discrete frequency spectrum according to the frequency differences. In the present embodiment, the processor 23 first performs a fast Fourier Transform on the frequency differences, and obtains the discrete frequency spectrum associated with the frequency differences after performing a Chirp-Z transform.

Step S30: The processor 23 selects a characteristic frequency from the discrete frequency spectrum. Detailed description of the step is presented later.

Step S40: The processor 23 calculates a measured result in the current cycle. The measured result in the current cycle is expressed by the following equation.

Rₙ=(Pₐ×Rₙ₋₁)+(P_{b}×R)

where

Rₙ₋₁: the measured result in the previous cycle;

Rₙ: the measured result in the current cycle;

Pₐ: the previous-cycle weight;

P_{b}: the current-cycle weight; and

R: a distance corresponding to the characteristic frequency.

The obtained measured result Rₙ in the current cycle is taken as the measured result Rₙ₋₁ in the previous cycle during next cycle of the measuring procedure. In the present embodiment, after calculating the measured result Rₙ in the current cycle, the processor 23 controls the current consumed by the power supply 25 so that the remote host 100 can detect the consumed current of the power supply 25 through the current detection terminal 251 and obtain the measured result Rn in the current cycle calculated in each cycle.

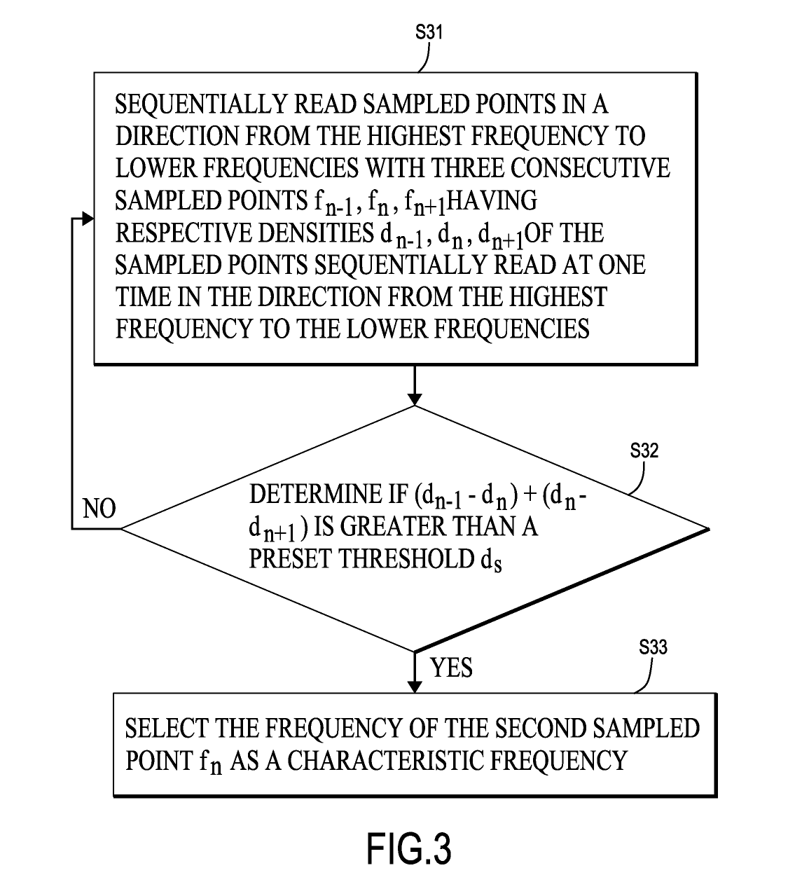

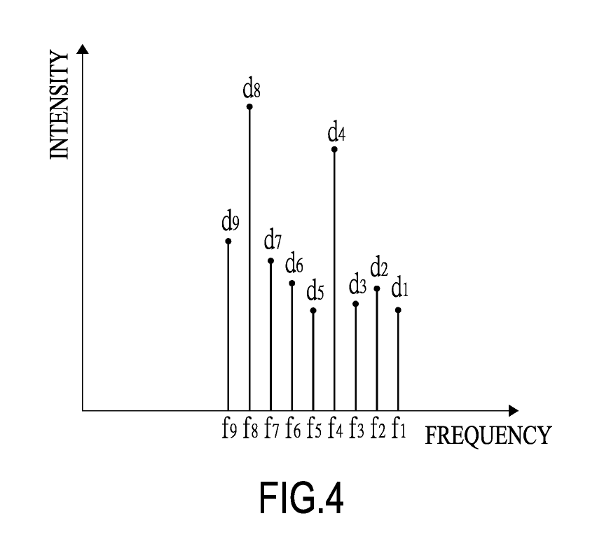

With reference to FIGS. 3 and 4, to adapt to measurement of river level in an open space, a characteristic sampled point corresponding to a highest frequency is selected from the discrete frequency spectrum, and the frequency of the characteristic sampled point is set as the characteristic frequency. The step S30 further has the following steps.

A characteristic sampled point reading step S31: Sequentially read sampled points in a direction from the highest frequency to lower frequencies. In the present embodiment, the highest frequency is pre-defined. Three consecutive sampled points fₙ₋₁, fₙ, fₙ₊₁ with respective densities dₙ₋₁, dₙ, dₙ₊₁ of the sampled points are sequentially read at one time in the direction from the highest frequency to the lower frequencies.

A characteristic sampled point determining step S32: Determine if a sum of a difference in intensity between the first sampled point and the second sampled point of the three consecutive sampled points read at one time and a difference in intensity between the second sampled point and the third sampled point of the three consecutive sampled points is greater than a preset threshold dₛ. If positive, go to next step, and if negative, return to the step S31 to continue reading the sampled points in the direction from the highest frequency toward lower frequencies.

A characteristic frequency determining step S33: Select the frequency of the second sampled point fₙ as a characteristic frequency.

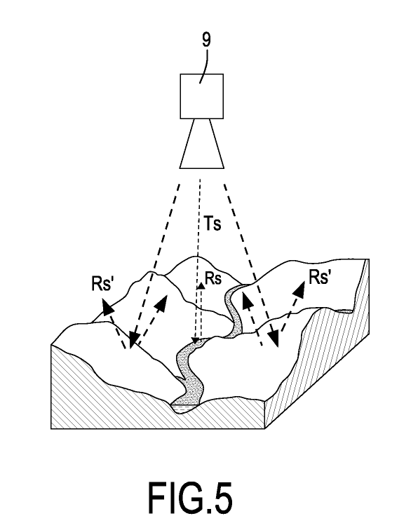

The preset threshold dₛ is user-configurable or can be configured as a fixed ratio of the intensity of the second sampled point dₙ, for example, one half of the intensity of the second sampled point dn. Given the preset threshold, it indicates determining if ((dₙ₋₁−dₙ)+(dₙ−dₙ₊₁)) is greater than 0.5dₙ. With further reference to FIG. 4, in the characteristic sampled point determining step S32, a sampled point f₄ meeting the condition statement in Step S32 and having the highest frequency and relatively high intensity is selected or f₄ is selected as the characteristic frequency. It is noted that a conventional FMCW radar level meter differs from the present invention in that the conventional FMCW radar level meter will select f₈, which corresponds to the peak intensity, for distance calculation. With reference to FIG. 5, as far as measuring river level in an open space is concerned, as the height of a river level is lower than that of all the neighboring ground, the measured distance from the FMCW radar level meter to the river level should be the lowest in comparison with the neighboring ground. Hence, it is preferable to select a characteristic frequency in favor of longer measured distance instead of selecting that having higher intensity. Since the measured distance is proportional to the characteristic frequency, a distance measured with the characteristic frequency f₄ is far more accurate than that measured with the frequency f₈ with the peak intensity.

When the FMCW radar level meter is used to measure river level and significant fluctuations, such as surge waves, occur on the river, a measure to tackle the fluctuations is to configure a larger value of the previous-cycle weight Rₙ₋₁ in the processor 23 and a smaller value of the current-cycle weight Rₙ. Given 0.9 and 0.1 respectively for Rₙ₋₁ and Rₙ₋₁ as an example, the measured result is equal to 0.9Rₙ₋₁+0.1R. Even if there is a great difference between the measured results in the current cycle and the previous cycle, after being weighted, the variation between the measured results in the current cycle and the previous cycle can be reduced so that the measured result in each cycle is converging and is therefore good for users' statistical analysis.

In sum, the FMCW radar level meter and the measuring method in accordance with the present invention make the measured result convergent in each cycle, and has higher accuracy when used to measure a liquid level in an open space, such as a river.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A measuring method for a frequency modulation continuous wave radar level meter, presetting a previous-cycle weight and a current-cycle weight less than the previous-cycle weight, and after acquiring a measured result in a previous cycle, the measuring method comprising steps of:
constantly transmitting a frequency modulation (FM) signal, constantly varying a frequency of the FM signal, and receiving multiple reflected signals of the FM signal;
performing down-conversion mixing processing of the FM signal and the reflected signals, obtaining a frequency difference between the FM signal and each reflected signal, and performing a Fourier transform to generate a discrete frequency spectrum according to the frequency differences;
selecting a characteristic frequency from the discrete frequency spectrum; and
calculating a measured result in the current cycle, wherein a sum of a first product of the measured result in the previous cycle and the previous-cycle weight and a second product of a distance corresponding to the characteristic frequency and the current-cycle weight is used to calculate a measured result in the current cycle, and the measured result in the current cycle is taken as the measured result in the previous cycle for calculating a measured result in a next cycle.

2. The measuring method as claimed in claim 1, wherein the step of selecting a characteristic frequency further includes a step of selecting a characteristic sampled point corresponding to a highest frequency from the discrete frequency spectrum, wherein a frequency of the characteristic sampled point is taken as a characteristic frequency.

3. The measuring method as claimed in claim 2, wherein the step of selecting a characteristic sampled point further includes:
a characteristic sampled point reading step of sequentially reading sampled points in a direction from the highest frequency to lower frequencies, wherein three consecutive sampled points with respective densities are sequentially read at one time from the highest frequency to the lower frequencies; and
a characteristic sampled point determining step of determining if a sum of a first difference in intensity between a first sampled point and a second sampled point of the three consecutive sampled points read at one time and a second difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

4. The measuring method as claimed in claim 3, wherein in the characteristic sampled point reading step, a sampled point with the highest frequency is pre-defined and the sampled points are read in the direction from the highest frequency to the lower frequencies.

5. A frequency modulation continuous wave (FMCW) radar level meter, comprising:
a transceiving antenna;
a processing unit connected to the transceiving antenna, built in with a measuring procedure, a previous-cycle weight, and a current-cycle weight, after acquiring a measured result in a previous cycle, the processing unit periodically performing the measuring procedure, when performing the measuring procedure, the processing unit constantly transmitting a frequency modulation (FM) signal, constantly varying a frequency of the FM signal, receiving multiple reflected signals of the FM signal, performing down-conversion mixing processing of the FM signal and the reflected signals, obtaining a frequency difference between the FM signal and each reflected signal, generating a frequency spectrum according to the frequency differences, selecting a characteristic frequency from the frequency spectrum, calculating a measured result in the current cycle with a sum of a product of the measured result in the previous cycle and the previous-cycle weight and a product of a distance corresponding to the characteristic frequency, and setting the measured result in the current cycle as the measured result in the previous cycle for calculating a measured result in a next cycle.

6. The FMCW radar level meter as claimed in claim 5, wherein the processing unit has:
a transmitter connected to the transceiving antenna, and outputting the FM signal to the transceiving antenna for the transceiving antenna to transmit the FM signal;
a receiver connected to the transceiving antenna and the transmitter to receive the reflected signals from the transceiving antenna and receive the FM signal from the transmitter, and having a down-conversion mixer, wherein the down-conversion mixer performs down-conversion mixing processing of the FM signal and the reflected signals to obtain the frequency differences between the FM signal and each of the reflected signals, and output beat signals according to the frequency differences; and
a processor connected to the transmitter and the down-conversion mixer of the receiver, built in with the measuring procedure, the previous-cycle weight, and the current-cycle weight, and periodically performing the measuring procedure.

7. The FMCW radar level meter as claimed in claim 6, wherein the processing unit further has:
an operation interface connected to the processor, and serving to set up the previous-cycle weight and the current-cycle weight;
a power supply connected to the processor for the processor to adjust consumed current of the power supply, and having a current detection terminal adapted to connect to a remote host for the remote host to detect the consumed current of the power supply;
a display connected to the processor, and serving to display the previous-cycle weight and the current-cycle weight; and
a communication port connected to the processor adapted for the remote host to set up the previous-cycle weight and the current-cycle weight in the processor.

8. The FMCW radar level meter as claimed in claim 5, wherein a characteristic sampled point corresponding to a highest frequency is selected from the frequency spectrum, and a frequency of the characteristic sampled point is taken as the characteristic frequency.

9. The FMCW radar level meter as claimed in claim 6, wherein a characteristic sampled point corresponding to a highest frequency is selected from the frequency spectrum, and a frequency of the characteristic sampled point is taken as the characteristic frequency.

10. The FMCW radar level meter as claimed in claim 7, wherein a characteristic sampled point corresponding to a highest frequency is selected from the frequency spectrum, and a frequency of the characteristic sampled point is taken as the characteristic frequency.

11. The FMCW radar level meter as claimed in claim 5, wherein selecting a characteristic sampled point from the frequency spectrum includes:
a characteristic sampled point reading step of sequentially reading sampled points in a direction from a highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

12. The FMCW radar level meter as claimed in claim 6, wherein selecting a characteristic sampled point from the frequency spectrum includes:
a characteristic sampled point reading step of sequentially reading sampled points in a direction from a highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

13. The FMCW radar level meter as claimed in claim 7, wherein selecting a characteristic sampled point from the frequency spectrum includes:
a characteristic sampled point reading step of sequentially reading sampled points in a direction from a highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

14. The FMCW radar level meter as claimed in claim 8, wherein selecting a characteristic sampled point from the frequency spectrum includes:
a characteristic sampled point reading step of sequentially reading sampled points in a direction from the highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

15. The FMCW radar level meter as claimed in claim 9, wherein selecting a characteristic sampled point from the frequency spectrum includes:
a characteristic sampled point reading step of sequentially reading sampled points in a direction from a highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the highest frequency to the lower frequencies.

16. The FMCW radar level meter as claimed in claim 10, wherein selecting a characteristic sampled point from the frequency spectrum includes:
a characteristic sampled point reading step of sequentially reading sampled points in a direction from a highest frequency to lower frequencies, wherein three consecutive sampled points with respective densities of the sampled points are sequentially read at one time from the highest frequency to the lower frequencies; and
a characteristic sampled point determining step of determining if a sum of a difference in intensity between a first sampled point and a second sampled point of the three consecutive sampled points read at one time and a difference in intensity between the second sampled point and the third sampled point of the three consecutive sampled points is greater than a preset threshold, if positive, determining that a frequency corresponding to the second sampled point is the characteristic frequency, and if negative, resuming the characteristic sampled point reading step to continue reading the sampled points in the direction from the higher frequency to the lower frequencies.
